(19) United States
(12) Patent Application Publication
(10) Pub. No.: US 2018/0304773 A1
(43) Pub. Date: Oct. 25, 2018

(54) CONTROL DEVICE AND METHOD, SEAT MODULE AND ASSOCIATED COMPUTER PROGRAM

(71) Applicant: ZODIAC ACTUATION SYSTEMS, AUXERRE (FR)

(72) Inventors: Tom LEROUGE, PARIS (FR); Pascal GORDIET, SAINT GEORGES SUR LA PREE (FR)

(21) Appl. No.: 15/492,634

(22) Filed: Apr. 20, 2017

(51) Int. Cl. B60N 2/02; B60N 2/00; B64D 11/06; B64D 11/00

(52) U.S. Cl. CPC B60N 2/0244; B60N 2/002; B64D 11/064; B64D 2011/0053; B64D 11/0015; B60N 2002/0268; B64D 11/0643

(57) ABSTRACT

Disclosed is a control device for comfort equipment for a seat module in a passenger transport vehicle. The control device includes a control unit capable of transmitting adjustment commands to a piece of comfort equipment, and one imager capable of acquiring one image representing a part of the body of a passenger resting on a seat. The control unit communicates with the imager to receive the one acquired image. The control unit is capable of detecting an object in the image representing a part of the passenger's body and generating one adjustment command to be sent to the comfort equipment as a function of the detected part of the passenger's body.

The domain of this invention is seat modules for passenger transport vehicles and particular aircraft seat modules.

Specifically, this invention relates to a control device for comfort equipment on a seat module, a seat module and method of controlling this comfort equipment. The invention also relates to a computer program.

Passengers in first class or business class enjoy a seat module usually called a “cabin”, equipped with many items of comfort equipment for example such as a seat height control device, a seat back pivot control device, a leg rest pivot control device, a seat bottom depth control device, an individual lighting device and an active noise control device.

This comfort equipment is usually controlled by a remote control or a tablet supplied to the passenger.

The purpose of this invention is to improve the passenger's comfort level.

To achieve this, the purpose of the invention is a comfort control device for a seat module in a passenger transport vehicle, said seat module comprising at least one piece of comfort equipment and a seat with seat bottom and a seat back, said control device comprising a control unit capable of transmitting adjustment commands to said comfort equipment, characterized in that said control device also comprises at least one imager capable of acquiring at least one image representing at least part of the body of a passenger resting on said seat,

and in which the control unit communicates with said imager to receive said at least one acquired image, said control unit being capable of detecting an object in the image representing at least part of the passenger's body and generating at least one adjustment command to be sent to the at least one piece of comfort equipment as a function of said detected part of the passenger's body.

Advantageously, this control device can provide automatic adjustment of the different comfort equipment without the passenger needing to take any action.

Advantageously, this seat module is very easy to use.

The control device comprises one or several of the following characteristics, depending on the particular embodiment:
The comfort equipment is a seat bottom height actuator capable of moving the seat bottom along a direction approximately perpendicular to the seat bottom, said passenger having legs, the control unit being capable of detecting an object in the image representative of at least one leg, said control unit being capable of determining the length of said at least one leg and generating at least one seat bottom height adjustment command as a function of the determined length.
The comfort equipment is a seat bottom depth actuator capable of moving the seat bottom along a direction approximately perpendicular to the seat back, said passenger having thighs, the control unit being capable of detecting an object in the image representative of at least one thigh, said control unit being capable of determining the length of said at least one thigh and generating at least one seat bottom depth (P) adjustment command as a function of the determined thigh length.
The comfort equipment is a seat back pivot actuator, said passenger having eyelids, the control unit being capable of detecting an object in the image representative of at least one closed eyelid, said control unit being capable of generating at least one seat back pivot command when it detects a closed eyelid.
The seat comprises a leg rest. The comfort equipment is a leg rest pivot actuator, said passenger having eyelids, the control unit being capable of detecting an object in the image representative of at least one closed eyelid, said control unit being capable of generating at least one seat leg rest pivot command when it detects a closed eyelid.
The comfort equipment is a lighting device, said passenger having eyelids, the control unit being capable of detecting an object in the image representative of at least one closed eyelid, said control unit being capable of generating a dim light command when it detects a closed eyelid.
The comfort equipment includes a loud speaker free to move relative to the seat, and at least one loud speaker displacement actuator capable of moving said loud speaker, said passenger having ears,

and in which the control unit is capable of localizing the position of at least one ear by detection of an object in the image representative of said ear, said control unit being adapted to generate at least one command to move the loud speaker as a function of the location of said ear.
The comfort equipment is an active noise control device in which said loud speaker is the loud speaker of the active noise control device.
The loud speaker movement actuator is capable of moving said loud speaker along at least one predefined direction among a direction approximately perpendicular to the seat bottom and a direction approximately perpendicular to the seat back.
The loud speaker movement actuator is capable of making the loud speaker pivot about an axis parallel to the pivot axis of the seat back.

Another purpose of the invention is a seat module for a passenger transport vehicle, said seat module comprising:
a seat with a seat bottom, a seat back and a leg rest,
at least one piece of comfort equipment among a seat bottom height actuator, a seat bottom depth actuator, a seat back pivot actuator, a leg rest pivot actuator, a lighting device and a loud speaker movement actuator, and a control device as mentioned above.

As a variant, the seat module also comprises a table free to move between a retracted position and an extracted position, in which said imager is capable of imaging said table when the table is in the extracted position, the control unit being capable of blocking movement of the seat bottom in the direction of the seat bottom when the table is in the extracted position.

As a variant, the imager is configured to image the head rest, and the control unit is capable of moving the at least one loud speaker and/or the active noise control device as a function of the position of the head rest.

Another purpose of the invention is a method of controlling comfort equipment on a seat of a passenger transport vehicle, said method being implemented by at least one imager and a control unit comprising a calculation unit and a memory including predetermined parameters, said control unit communicating with said at least one imager, said method including the following steps:
acquire an image representing a passenger seated on the seat,
detect at least one object in the image representing at least part of the passenger's body,
determine bodily characteristics of the passenger starting from the detected object and predetermined parameters, and
generate at least one command for adjustment of comfort equipment as a function of the determined bodily characteristics.

As a variant, the method also includes a timeout step with a predefined duration, said timeout step taking place after the adjustment controls have been generated.

Finally, another purpose of the invention is a computer program containing instructions for implementing the control process mentioned above when the program is executed by a calculation unit.

The invention will be better understood after reading the following description, given purely as examples, with reference to the figures on which:

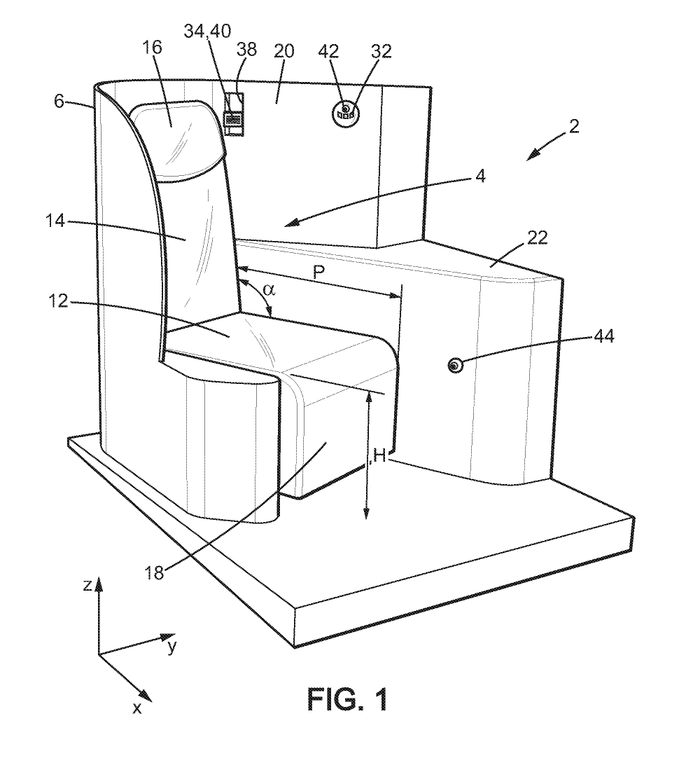

FIG. 1 is a perspective view of a seat module according to this invention.

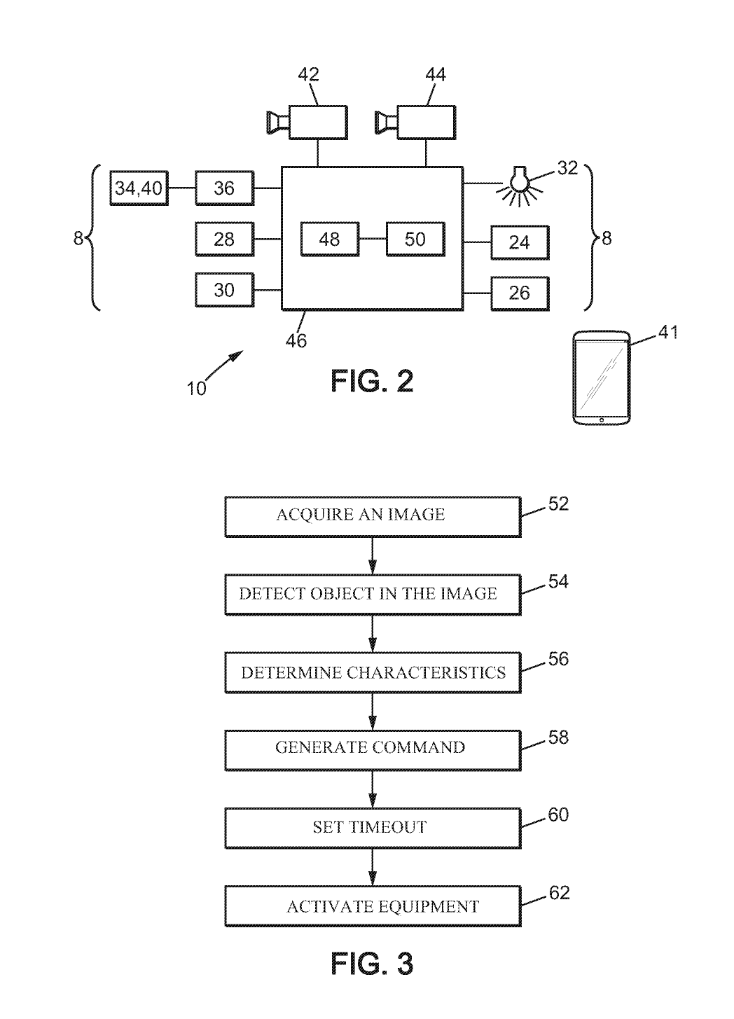

FIG. 2 is a diagrammatic view of the control device according to this invention, and

FIG. 3 is a diagram showing the steps in the control process according to this invention.

FIG. 1 shows an example of a seat module 2 according to the invention. Such a seat module 2 may for example be installed in a passenger transport vehicle. Typically, such a seat transport module may be installed in a first class or business class area of a passenger transport aircraft.

This seat module 2 comprises a seat 4, a shell 6, comfort equipment 8 and a control device 10 capable of controlling this comfort equipment.

The seat 4 comprises a seat bottom 12, a seat back 14, a head rest 16 and a leg rest 18.

In the example shown, the shell 6 surrounds the back and the sides of the seat 4. It is prolonged at the side of the seat by a vertical wall 20 truncated at mid-height to for a work table 22.

In the example shown on FIG. 2, the comfort equipment 8 comprises a seat bottom height actuator 24, a seat bottom depth actuator 26, a seat back pivot actuator 28 and a leg rest pivot actuator 30 formed in the shell 6.

The seat bottom height actuator 24 is capable of moving the seat bottom vertically to modify its height H. The seat bottom depth actuator 26 is capable of moving the seat bottom horizontally, in the front-back direction, to modify the depth P of the seat bottom.

The seat back pivot actuator 28 is adapted to pivot the seat back 14 relative to the seat bottom 12 by an angle α about an axis extending along the y direction relative to the orthogonal coordinate system (x, y, z) represented on FIG. 1. The leg rest pivot actuator 30 can pivot the leg rest 18 about an axis extending along the y direction.

The comfort equipment 8 also comprises a lighting device 32, loud speakers 34 and loud speaker movement actuators 36.

In the example shown, the lighting device 32 comprises three light sources that may for example be composed of light emitting diodes. Preferably, these light emitting diodes have an adjustable light intensity. The lighting device 32 is formed on the vertical wall 20 of the shell 6 at a height corresponding to the height of the head rest 16.

The loud speakers 34 are mounted on the walls of the shell 6 extending on each side of the head rest 16.

In the example embodiment illustrated on FIG. 1, the loud speakers 34 are mounted on vertical slides 38 and the loud speaker movement actuators 36 are capable of moving them vertically.

According to one variant not shown, the loud speakers 34 are mounted on horizontal slides and the loud speaker movement actuators 36 are capable of moving them horizontally to move them closer to or further away from the head rest 16.

According to another variant not shown, the loud speakers 34 are arranged to pivot about an axis extending along the y direction, parallel to the seat back pivot axis.

For example, the loud speakers 34 form part of an active noise control device 40. In this case, a microphone is positioned close to each loud speaker. These microphones are then also moved by movement actuators 36.

The loud speakers 34 can also be used to broadcast musical or voice recordings related to a displayed video or to transmit announcements broadcast by the airline.

The control device 10 for this comfort equipment is shown diagrammatically on FIG. 2. It comprises a tablet 41 or a remote control for the manual commands for comfort equipment 8; a first imager 42; a second imager 44 and a control unit 46 communicating with the first imager 42 and the second imager 44; for example through wire communication links.

The tablet 41 or the remote control are capable of receiving adjustment commands generated by the passenger for comfort devices 8. These adjustment commands include, for example; commands to raise the seat bottom, pivot the seat back 14 or the leg rest 18.

The images 42, 44 are for example, composed of a camera or cyber camera (webcam).

In the example embodiment represented on FIG. 1, the first imager 42 is arranged in the shell 6 on a part of the vertical wall 20 that extends to the height of the head rest. It is capable of acquiring at least one image representing the upper part of the passenger's body. In particular, the first imager 42 is capable of imaging the passenger's thighs and face and more particularly his or her eyes and eyelids.

Preferably, the light sources 32 and the imagers 42 and 44 are flush with the surface of the vertical wall. Advantageously, this arrangement is aesthetic.

The second imager 44 is arranged in the shell 6 on a part of the vertical wall that extends to the height of the leg rest 18. It is capable of acquiring at least one image representing the lower part of the passenger's body. In particular, the second imager 44 is capable of imaging the passenger's legs.

As a variant, the control device 10 comprises a single imager capable of imaging the passenger as a whole.

As a variant, the control device 10 comprises more than two imagers.

With reference to FIG. 2, the control unit 46 comprises a memory 48 and a calculation unit 50 connected to the memory 48. For example, it consists of a processor.

The memory 48 includes instructions to execute the command process according to the invention and predetermined parameters.

The predetermined parameters are parameters used by the control unit to determine the length of some parts of the body, starting from the acquired image.

For example, these parameters include predefined average length measurements between each imager and parts of the body that the control unit is required to detect or measurements of the length of seat elements that are also displayed on the images. These length measurements are used to determine the length of some parts of the body starting from the acquired image and applying a proportionality calculation.

The control unit 46 is capable of receiving images acquired by the first imager 42 and the second imager 44.

The control unit 46 is capable of applying a segmentation and contour detection type image processing to detect an object representative of at least part of the passenger's body in the image. The control unit 46 is capable of generating at least one adjustment command to be sent to a piece of comfort equipment 8 as a function of said detected part of the passenger's body.

Thus, the control unit 46 may for example be capable of detecting an object in the image representative of at least one of the passenger's legs and determining the length of this leg from predetermined parameters. The control unit 46 is then capable of generating at least one seat bottom height H adjustment command as a function of the determined length and transmitting this command to the seat bottom height actuator 24.

The control unit 46 is capable of detecting an object in the image representative of a passenger's thigh and determining the length of this thigh from predetermined parameters. The control unit 46 is capable of generating a seat bottom depth P adjustment command as a function of the determined thigh length and transmitting this command to the seat bottom depth actuator 26.

The control unit 46 is capable of locating the position of at least one of the ears of a passenger sitting on the seat by detection of an object in the image representative of the passenger's ear. The control unit 46 is capable of generating a loud speaker movement command as a function of the determined ear location and transmitting this command to the loud speaker movement actuator 36.

The control unit 46 is capable of detecting an object in the image representative of at least one closed eyelid of the passenger sitting on the seat. The control unit is capable of generating a command to pivot the seat back when the passenger's eyelid is closed, and sending it to the seat back pivot actuator 28.

When the passenger's eyelid is closed, the control unit 46 can also generate a command to pivot the leg rest and transmit this command to the leg rest pivot actuator 30.

Finally, when the passenger's eyelid is closed, the control unit can also generate a command to dim the lighting or a command to switch the lighting device off and send this command to the lighting device 32.

The calculation unit 50 is capable of executing the instructions in the command process recorded in the memory.

With reference to FIG. 3, the command process according to this invention begins with a step 52 for the acquisition of one or several image(s) representing a passenger resting on the seat.

During a step 54, the control unit 46 detects an object in the image representative of at least one part of the passenger's body.

During a step 56, the control unit 46 determines the bodily characteristics of the passenger from the detected object. These bodily characteristics are for example the length of a thigh or the presence of a closed eyelid.

During a step 58, the control unit 46 generates a command to adjust a piece of comfort equipment as a function of the determined bodily characteristics and predetermined parameters.

During a step 60, the control unit controls a timeout. The control unit 46 does this after waiting for a predetermined duration before sending the command generated during step 58.

During a step 62, the piece of comfort equipment 8 receives the command sent by the command unit. This command actuates the control equipment or puts it into operation.

Advantageously, the timeout makes the command smoother, without surprising the passenger.

According to one advantageous embodiment, the seat module comprises a retractable table used particularly to support meal trays. This table is free to move between a position in which it is housed in a housing of the vertical wall 20 and a position in which it is extracted from this housing. The first imager 42 is capable of imaging this table when it is in an extended position. The control unit 46 is capable of detecting the presence of the retractable table at the passenger's thighs by processing of the image acquired by the first imager. When the extracted position of the retractable table is detected, the control unit is capable of blocking displacement of the seat bottom 12 towards the table to avoid trapping the passenger's thighs.

According to one advantageous variant, the first imager 42 is capable of imaging the head rest 16. The control unit 46 is capable of detecting the position of the head rest 16 by processing of the image acquired by the first imager 42. The control unit 46 is capable of moving one of the loud speakers 34 and/or the active noise control device 40 as a function of the position of the head rest. In particular, the loud speaker(s) 34 and/or the active noise control device 40 are moved so that they are positioned at a height corresponding to the mid-height of the head rest.

1-16. (canceled)

17. Control device for comfort equipment for a seat module in an passenger transport vehicle, said seat module comprising at least one piece of comfort equipment and a seat with seat bottom and a seat back, said control device comprising a control unit capable of transmitting adjustment commands to said comfort equipment, characterized in that said control device also comprises at least one imager capable of acquiring at least one image representing at least part of the body of a passenger resting on said seat,
and in which the control unit communicates with said imager to receive said at least one acquired image, said control unit being capable of detecting an object in the image representing at least part of the passenger's body and generating at least one adjustment command to be sent to the at least one piece of comfort equipment as a function of said detected part of the passenger's body.

18. Control device according to claim 17, in which said comfort equipment is a seat bottom height actuator capable of moving the seat bottom along a direction approximately perpendicular to the seat bottom, said passenger having legs, the control unit being capable of detecting an object in the image representative of at least one leg, said control unit being capable of determining the length of said at least one leg and generating at least one seat bottom height adjustment command as a function of the determined length.

19. Control device according to claim 17, in which said comfort equipment is a seat bottom depth actuator capable of moving the seat bottom along a direction approximately perpendicular to the seat back, said passenger having thighs, the control unit being capable of detecting an object in the image representative of at least one thigh, said control unit being capable of determining the length of said at least one leg and generating at least one seat bottom depth adjustment command as a function of the determined thigh length.

20. Control device according to claim 17, in which said comfort equipment is a seat back pivot actuator, said passenger having eyelids, the control unit being capable of detecting an object in the image representative of at least one closed eyelid, said control unit being capable of generating at least one seat back pivot command when it detects a closed eyelid.

21. Control device according to claim 17; the seat comprising a leg rest and in which said comfort equipment is a leg rest pivot actuator, said passenger having eyelids, the control unit being capable of detecting an object in the image representative of at least one closed eyelid, said control unit being capable of generating at least one leg rest pivot command when it detects a closed eyelid.

22. Control device according to claim 17, in which said comfort equipment is a lighting device, said passenger having eyelids, the control unit being capable of detecting an object in the image representative of at least one closed eyelid, said control unit being capable of generating a dim light command when it detects a closed eyelid.

23. Control device according to claim 17, in which said comfort equipment includes a loud speaker free to move relative to the seat, and at least one loud speaker displacement actuator capable of moving said loud speaker, said passenger having ears, and in which the control unit is capable of localizing the position of at least one ear by detection of an object in the image representative of said ear, said control unit being adapted to generate at least one command to move the loud speaker as a function of the location of said ear.

24. Control device according to claim 23, in which said comfort equipment is an active noise control device in which said loud speaker is the loud speaker of the active noise control device.

25. Control device according to claim 23, in which the loud speaker movement actuator is capable of moving said loud speaker along at least one predefined direction among a direction approximately perpendicular to the seat bottom and a direction approximately perpendicular to the seat back.

26. Control device according to claim 23, in which the loud speaker movement actuator is capable of making the loud speaker pivot about an axis parallel to the pivot axis of the seat back.

27. Seat module for a passenger transport vehicle, said seat module comprising:
a seat with a seat bottom, a seat back and a leg rest,
at least one piece of comfort equipment among a seat bottom height actuator, a seat bottom depth actuator, a seat back pivot actuator, a leg rest pivot actuator, a lighting device and a loud speaker movement actuator, and
a control device according to claim 17.

28. Seat module according to claim 27, that also comprises a table free to move between a retracted position and an extracted position, in which said imager is capable of imaging said table when the table is in the extracted position, the control unit being capable of blocking movement of the seat bottom in the direction of the seat bottom when the table is in the extracted position.

29. A seat module comprising:
a seat with a seat bottom, a seat back and a leg rest,
at least one piece of comfort equipment among a seat bottom height actuator, a seat bottom depth actuator, a seat back pivot actuator, a leg rest pivot actuator, a lighting device and a loud speaker movement actuator, and
a control device according to claim 17, in which said comfort equipment includes a loud speaker free to move relative to the seat, and at least one loud speaker displacement actuator capable of moving said loud speaker, said passenger having ears,
and in which the control unit is capable of localizing the position of at least one ear by detection of an object in the image representative of said ear, said control unit being adapted to generate at least one command to move the loud speaker as a function of the location of said ear,
wherein said imager is configured to image the head rest, and in which the control unit is capable of moving the at least one loud speaker and/or the active noise control device as a function of the position of the head rest.

30. Method of controlling comfort equipment on a seat of a passenger transport vehicle, said method being implemented by at least one imager and a control unit comprising a calculation unit and a memory including predetermined parameters, said control unit communicating with said at least one imager, said method including the following steps:
acquire an image representing a passenger seated on the seat,
detect at least one object in the image representing at least part of the passenger's body,
determine bodily characteristics of the passenger starting from the detected object and predetermined parameters, and
generate at least one command for adjustment of comfort equipment as a function of the determined bodily characteristics.

31. Control method according to claim 30, that also includes a timeout step with a predefined duration, said timeout step taking place after the adjustment controls have been generated.

32. A nontransitory computer-readable medium on which is stored a computer program containing instructions for implementing the control process according to claim 30 when the program is executed by a calculation unit.
